(19) United States
(12) Patent Application Publication
(10) Pub. No.: US 2007/0298485 A1
(43) Pub. Date: Dec. 27, 2007

(54) Method for Separation of Glycosaminoglycan From Core Protein of Proteoglycan with the Use of Xylanase

(76) Inventors: Keiichi Takagaki, Aomori (JP); Satoshi Kaneko, Ibaraki (JP); Atsushi Kuno, Ibaraki (JP)

Correspondence Address: Flynn, Thiel, Boutell & Tanis, P.C., 2026 Rambling Road, Kalamazoo, MI, 49008-1699, US

(21) Appl. No.: 10/580,279

(22) PCT Filed: Nov. 26, 2003
(86) PCT No.: PCT/JP03/15091

§ 371 Date: Apr. 16, 2007

(51) Int. Cl. C08B 37/18; C12S 3/02

(52) U.S. Cl. 435/274

(57) ABSTRACT

A method for collection of intact glycosaminoglycan from proteoglycan by cleaving a linkage region of core protein

### FIELD OF THE INVENTION

A method for collection of intact glycosaminoglycan from proteoglycan by cleaving a linkage region of core protein

### BACK GROUND OF THE INVENTION

A proteoglycan molecule as a complex is a macromolecule that consist of several or several tens chains of huge glycosaminoglycan (GAG) whose molecular weight is from several thousands to several hundreds of thousands are linked to one scaffold protein having a structure called as a core protein whose molecular weight is from several ten thousands to several hundreds of thousands (refer to FIG. 1). GAG can be classified to several kinds such as hyaluronic acid, chondroitin sulfate, dermatan sulfate or keratan sulfate according to a basic construction of the GAG component. However, basically, these GAGs are a hetero acidic polysaccharide composed of disaccharide repetition structure of amino sugar and uronic acid, and GAG except hyaluronic acid are bound to core protein and forms proteoglycan.

And, proteoglycan is generally existing in almost all animal tissue as an important component of extracellular matrix which exists between cells and not only plays an important role for construction of animal tissue, but also forms physical environment surrounding cells, and controls various actions such as adhesion, proliferation or differentiation of cells.

The GAG also possesses a different function depending on biological informational signal structure, therefore, if it is possible to bind an another GAG to a core protein, it becomes possible to synthesis artificially a proteoglycan which does not exist in an original animal tissue. That is, it becomes possible to produce a quite new substance biochemically. However, for the purpose to realize above mentioned conception, it is necessary to separate intact GAG.

As mentioned above, proteoglycan is a macromolecule characterized that xylose of GAG is linked to Ser of core protein (Xyl-Ser linkage), and for the method to collect GAG, a method to collect only GAG by digestion of core protein with proteolytic enzyme is conventionally used, further, a method to cleave by endo-β-xylosidase, which was already filed as an application for patent by the inventor, is proposed.

However, by the method to use proteolytic enzyme, GAG can not be collected by a perfect form. Further, since this enzyme is not marketed, it is difficult to treat large quantity of proteoglycan.

### DISCLOSURE OF THE INVENTION

Patenopecten Mid-gut Gland endo-β-xylosidase is an enzyme which is possible to cleave intact GAG by hydrolysis of Xyl-Ser. However, it has a weak point that it takes very long time and high expenses for preparation of it and prepared quantity of it is very small. Therefore, the inventors have noticed xylanase from bacteria which is cheap and can be prepared in large quantities in short time, and have carried out screening of endo-β-xylosidase activity using several xylanases. Further the inventors have found out optimal condition to carry out the cleaving of glycosaminoglycans, and accomplished the present invention.

### BRIEF IRRASTRATION OF THE DRAWINGS

FIG. 1 is a schematic view of extracellular matrix and proteoglycan.

FIG. 2 is a comparison of endo-β-xylosidase activity using 5 kinds of xylanase

FIG. 3 is analyzing results of enzyme reaction products by HPLC to investigate a function of xylanase to MU-GAG

FIG. 4 is analyzing results of reducing terminal of hydrolysis reaction when a substrate is MU-GAG

FIG. 5 is investigation results of optimal pH of hydrolysis to MU-GAG of xylanase from Streptomyces olivaceoviridis

FIG. 6 is a graph indicating the change by time lapse to clarify the characteristic of xylanase Streptomyces olivaceoviridis to MU-GAG

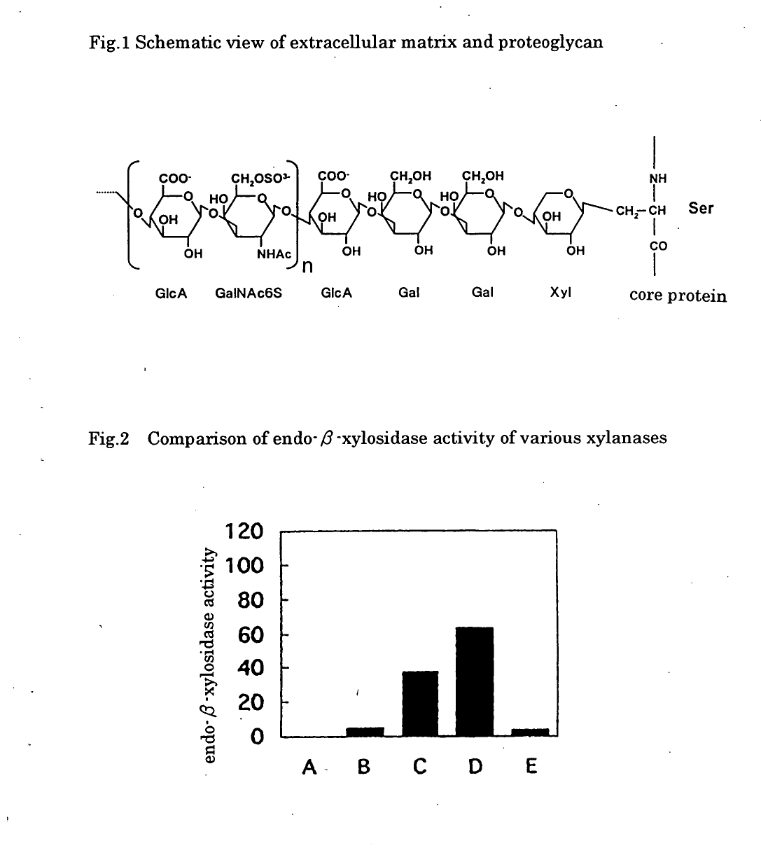

### DESCRIPTION OF THE PREFFERD EMBOBYMENT

The present invention will be illustrated more specifically.

Screening of endo-β-xylosidase activity is carried out by making MU-GAG having 4-methylumbelliferone (MU) at reducing terminal, after reaction, released MU is measured by a fluorophotometer. Further, as a natural substrate, peptide chondroitin sulfate from salmon nose cartilage (peptide-ChS), dermatan sulfate from pig skin or heparan sulfate from bovine lung (HS) are used and analyzed by a high-performance liquid chromatography (HPLC).

Xylanases which are selected as an investigation object to accomplish the present invention are following 5 kinds.

(A) Aureobasidium pullulans originated

(B) Thermomyces lanuginosus originated

(C) Trichoderma viride originated

(D) Streptomyces olivaceoviridis originated

(E) Streptomyces lividans originated

Xylanases from Thermomyces lanuginosus and Trichoderma viride are purchased from Sigma (St. Louis, Mo., USA). Xylanases from Streptomyces olivaceoviridis and Streptomyces lividans are treated by HiTrap chelating column affinity chromatography, then concentrated and desalted by ultrafiltration, and preserved in 20 mM sodium phosphate buffer solution at 4° C.

As MU-GAG, which is an artificial substrate of endo-β-xylosidase activity, MU-GAG which is prepared from cultured medium of human skin fibroblasts is used. MU-oligosaccharide is prepared by digesting with hyaluronidase then carried out by Bio-Gel P-4 column chromatography. P-nitrophenyl Xyl-Xyl (PNP-X2) is synthesized from prepared from xylobiose which is obtained by purifying xylobiose mixture (Suntory Ltd.). As actinase E, product of Kaken Pharmaceutical Co., Ltd. is used.

Proteo-chondroitin sulfate (Proteo-Chs), proteo-dermatan sulfate (Proteo-DS) and proteo-heparan sulfate are respectively obtained by purifying salmon nose cartilage, pig skin and bovine lung according to Heinegard and Hascall. To obtain Peptide-Chs, Peptide-DS and Peptide-HS, above mentioned proteoglycans are digested by actinase in 0.1M Tris-HCl, pH 8.0, 10 mM CaCl₂ at 50° C. for 24 hours, then purified by Sephacryl S-200HR column.

Measuring method and measuring apparatus are illustrated as follows.

(Fluorescence Tracing by 2-Aminopyridine)

Fluorescence tracing (PA) at oligosaccharide reducing terminal is carried out according to the method of Hase et al. That is, 40 μM MU-GAG is used as a substrate, 50 μl of reaction mixture containing 0.1M sodium phosphate buffer and enzyme solution is incubated at 37° C. for ten minutes. Reaction is stopped by adding 1 ml of 0.5M glycine-NaOH buffer of pH10.4, and fluorescence of released MU is measured by a fluorometer (Hitachi F-4500, product of Hitachi Ltd.) at excitation wavelength (ex.) 350 nm and emission wavelength (em.) 450 nm. Value of activity is indicated by relative activated value when amount of enzyme indicating certain xylanase activity (measured by a condition mentioned below: amount of enzyme necessary to hydrolyze PNP-X₂, which is a substrate) is used. Measurement of xylanase activity is carried out as follows. That is, 0.8 mM PNP-X₂ is used as a substrate, 50 μl of reaction mixture containing 0.1M sodium phosphate buffer and enzyme solution is incubated at 37° C. for 10 minutes. Reaction is stopped by adding 1 ml of 0.02M NaOH, and absorbance of released PNP is measured at 405 nm.

(High Performance Liquid Chromatography)

As a high performance liquid chromatography mentioned below, HPLC (Hitachi L-6200, Hitachi Ltd.) equipping a fluorescence indicator (F-1150, Hitachi Ltd.) is used.

(MU Oligosaccharide and Mu)

Analysis of MU oligosaccharide and MU is carried out by Ultrasphere ODS column (4.6 mm×25 cm), as a solvent, acetonitrile of 0-30% by 0-50 minutes is used. At flow rate of 1.0 ml/min, fluorescence is measured at ex. 325 nm and em. 380 nm.

(Reducing Terminal Saccharide)

Analysis of PA saccharide at reducing terminal is carried out by Ultrasphere ODS column (4.6 mm×25 cm), as a solvent, 0.25M sodium citrate is used, and 1% acetonitrile is used. At flow rate 0.5 ml/min, fluorescence is measured at ex. 320 nm and em. 400 nm. PA-glucose, PA-galactose and PA-xylose are used as a standard.

(PA-GAGs)

Analysis of PA-GAGs is carried out by TSKgel DEAE-5PW column (7.5 mm×75 cm). PA-GAGs is eluted by linear gradient of 0-1M NaCl. At flow rate 1.0 ml/min, fluorescence is measured at ex. 325 nm and em. 380 nm.

### EXAMPLE

### Screening of Endo-β-Xylosidase Activity in Xylanase

5 kinds of xylanase, that is, originated from Aureobasidium pullulans (A), Thermomyces lanuginosus (B) and Trichoderma viride (C), which are pursuaded from the market, Streptomyces olivaceoviridis (D) and Streptomyces lividans (E), which are prepared, are used and endo-β-xylosidase activity is compared (FIG. 2). Each values are indicated by relative activity when amount of enzyme indicating certain xylanase activity is used. As the result, endo-β-xylosidase activity is detected on 4 kinds of xylanase except Aureobasidium pullulans. Among these, xylanase which indicates highest activity is Streptomyces olivaceoviridis, therefore, the inventors converged on the enzyme, and carry out following experiment to prove that Xyl-Ser linkage is actually hydrolyzed.

(Action of Xylanase from Streptomyces olivaceoviridis to MU-GAG)

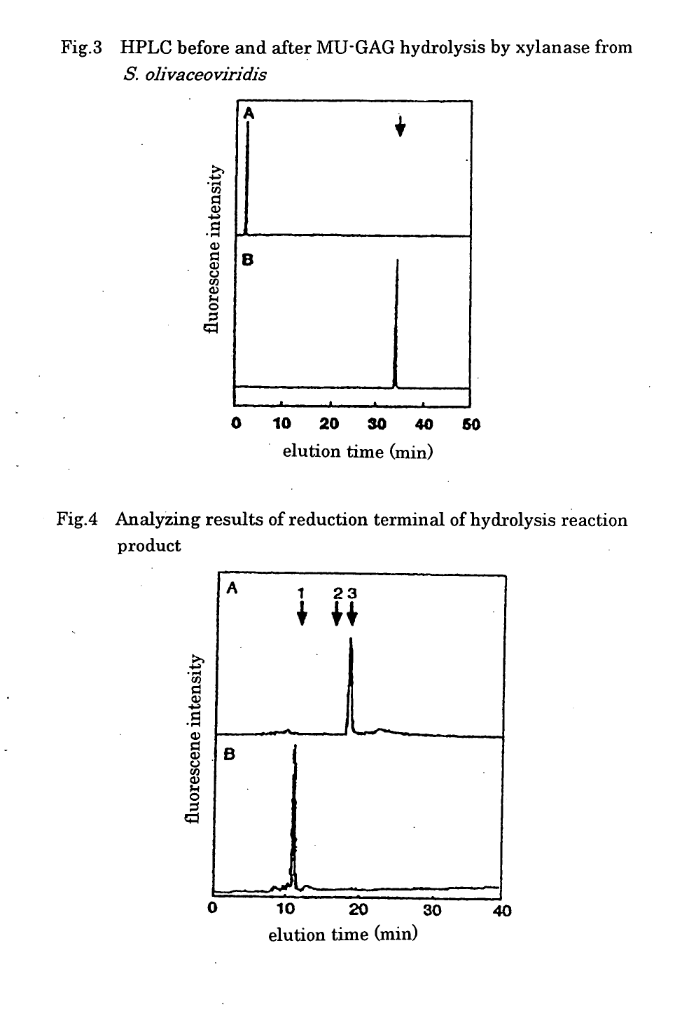

For the purpose to investigate the action of xylanase to MU-GAG, product from enzyme reaction is analyzed by HPLC (FIG. 3). In FIG. 3, A indicates before MU-GAG enzyme digestion, B indicates after MU-GAG enzyme digestion and an arrow mark indicates MU eluting position. A peak of MU-GAG disappears after enzyme digestion by xylanase, and a new peak appears at 33 minutes of retention time. This time is same with the retention time of standard MU.

After that, reducing terminal of saccharides of products by hydrolysis reaction when MU-GAG is used as a substrate is analyzed. That is, hydrolysis reaction product is labeled with 2-Aminopyridine, and hydrolyzed by 2 M HCl at 100° C. for 2 hours and analysis of PA-monosaccharide is carried out by HPLC (FIG. 4). In FIG. 4, arrow mark 1 indicates standard of PA-glucose, arrow mark 2 is PA-galactose and arrow mark 3 is PA-xylose. As a result, a peak is detected at the same retention time to standard PA-xylose. In this results, it is clearly that this enzyme has an endo-β-xylosidase activity which hydrolyzes xyloside linkage (MU-β-xyl) of MU-GAG by endo-type.

(Characteristics of Xylanase from Streptomyces olivaceoviridis in Endo-β-Xylosidase Activity)

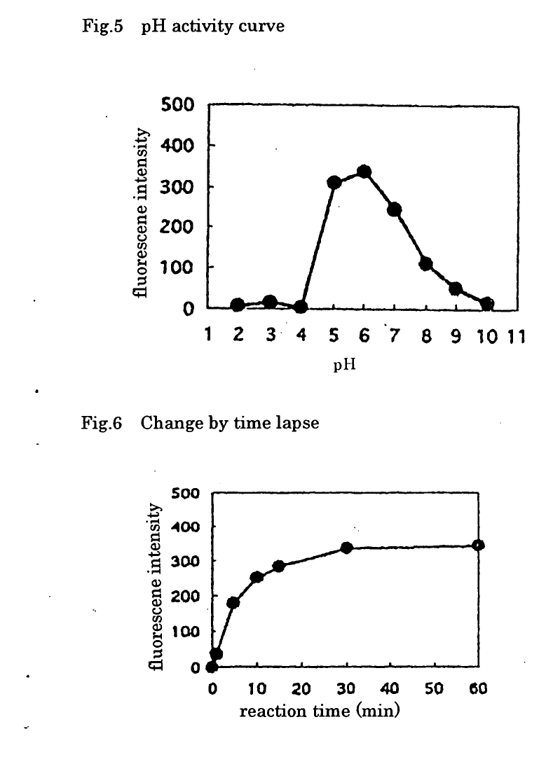

For the purpose to clarify the characteristics of this enzyme to MU-GAG, optimum pH of hydrolysis (FIG. 5) and time course of hydrolysis (FIG. 6) are analyzed. In FIG. 5, 0.1M glycine-HCl buffer is used for pH2, 0.1M citrate buffer is used for pH3-6, 0.1M Tris-HCl buffer is used for pH 7-8 and 0.1M glycine-NaOH buffer is used for pH 9-12. Optimum pH of hydrolysis when MU-GAG is used as a substrate is 6.0 and is approximately same with optimum pH 5.7 of xylanase activity. And, FIG. 6 shows that endo-β-xylosidase activity of this enzyme plateaued at 30 minutes in this condition.

(Effect of Gag Component)

Proteo-ChS, Proteo-DS and Proteo-HS have a different disaccharide repetition structure, however, a linking region with core protein is in common structure indicated by GlcA-Gal-Gal-Xyl-Ser. The inventors investigate an effect of GAG component to hydrolysis activity. Proteo-ChS, Proteo-DS and Proteo-HS are incubated with a purified enzyme at 37° C., pH 6.0 for 24 hours. After product was labeled with PA at reducing terminal, analyzed by HPLC (Table 1).

TABLE 1
Effect of GAG construction element to activity

| | relative activity |
|---|---|
| Peptide-ChS | 100 |
| Peptide-DS | 108 |
| Peptide-HS | 145 |

Activity to hydrolyze Peptide-ChS is fixed to 100, and indicated by relative value.

From these results, it becomes clear that the purified enzyme can hydrolyze Proteo-Chs, Proteo-DS and Proteo-HS and is effective for digestion of proteoglycan.

### POSSIBILITY FOR THE INDUSTRIAL USE

If it becomes possible to cleave intact GAG and can introduce it to a protein, it is possible to make a new proteoglycan.

Therefore, recombinant protein, which has problems on generation of physiological activity or stability of protein because of defect GAGs and imperfect linkage of GAGs from view point of genetic engineering, has a possibility that said problems will be dissolved by use of this method.

According to the present invention, proteoglycan can be synthesized artificially, development of new medicines can be expected by combining with genetic engineering.

1. A method for separation of glycosaminoglycan which comprises, using xylanase for separation of glycosaminoglycan from core protein of proteoglycan.

2. A method for separation of glycosaminoglycan of claim 1, wherein xylanase is from Streptomyces olivaceoviridis.
